(19) United States
(12) Patent Application Publication
(10) Pub. No.: US 2025/0327241 A1
(43) Pub. Date: Oct. 23, 2025

(54) PREPARATION METHOD AND APPLICATION OF AROMATIC CITRUS PEEL ARTIFICIAL LEATHER

(71) Applicant: ANAN (CHINA) CO., LTD., Zhangzhou (CN)

(72) Inventors: Xiaoyan FENG, Zhangzhou (CN); Tiansong LIN, Zhangzhou (CN); Zhengfu WANG, Zhangzhou (CN); Deye SU, Zhangzhou (CN); Yihui HE, Zhangzhou (CN); Ling LIN, Zhangzhou (CN)

(73) Assignee: ANAN (CHINA) CO., LTD., Zhangzhou (CN)

(21) Appl. No.: 18/672,673

(22) Filed: May 23, 2024

(30) Foreign Application Priority Data
Apr. 22, 2024 (CN) 202410483320.0

(51) Int. Cl. D06N 3/00; D06N 3/12

(52) U.S. Cl. CPC D06N 3/0011; D06N 3/0061; D06N 3/0077; D06N 3/0097; D06N 3/123; D06N 2203/061; D06N 2207/06; D06N 2209/0823; D06N 2211/106; D10B 2403/033; D10B 2501/00

(57) ABSTRACT

The present invention provides a preparation method of aromatic citrus peel artificial leather, the non-woven fabric adopts the wet impregnation process for impregnation treatment, the impregnated non-woven fabric is scraped and coated with the first fabric by the coating scraper, and then the aromatic citrus peel artificial leather finished product is obtained by coagulation, washing, pre-ironing, drying, cooling, scraping and coating of the second fabric; Liquid nitrogen is used to grind 80-400 mesh citrus peel powder in the fabric formula. The aromatic citrus peel artificial leather finished product has strong oxidation resistance, is not easy to turn yellow, has sterilization, deodorization and can exude a fresh aroma, and the artificial leather is environmentally friendly and easy to degrade.

### CROSS-REFERENCE TO RELATED APPLICATIONS

The application claims priority to Chinese patent application No. 202410483320.0, filed on Apr. 22, 2024, the entire contents of which are incorporated herein by reference.

### TECHNICAL FIELD

The present invention relates to the technical field of artificial leather, specifically relates to a preparation method and application of aromatic citrus peel artificial leather.

### BACKGROUND

In the past, the materials used to make leather were taken from animal skins, which had good physical properties, such as elasticity, abrasion resistance, and air permeability. However, at present, animal skins are scarce and difficult to be produced on a large scale, and because of high prices and environmental factors, they cannot be universally owned by ordinary consumers. In order to alleviate this situation, artificial leather as an alternative material came into being, artificial leather production cost is low, the product is generous and beautiful, and has a high degree of simulation. However, in recent years, with the improvement of living standards, consumers' attention to product safety and environmental protection has increased greatly. At present, the artificial leather produced in the market is made of synthetic polymer materials as raw materials, and a large amount of waste will be produced in the production process and toxic gases and wastewater are discharged, which is more serious to the environment, and the existing artificial leather can be degraded at the same time, and the waste artificial leather causes environmental pollution.

Material selection is one of the important solutions to sustainability-related issues. Citrus belongs to the citrus subfamily of the Rutaceae family, citrus is one of the main fruits in the south of our country, because of the color, fragrance and taste, sweet and sour, juicy, fragrant and refreshing, mellow flavor, rich in nutrition, deeply loved by people. The production and processing of citrus is accompanied by the formation of about 30%˜50% of the by-products of peel residue. First, the traditional processing industry will landfill or process these by-products into animal feed, and the other is directly treated as household waste. Because citrus peel residue is very easy to mildew and smelly, landfill treatment is bound to cause serious pollution to the environment, therefore, many countries in the world have carried out a lot of exploration and research on the processing and utilization of citrus by-products.

The existing artificial leather is easy to turn yellow when worn for a long time, and the artificial leather shoes are easy to produce peculiar smell after a long time of wearing. In view of this, the inventor of this case conducted an in-depth study of the above issues, and this case came about.

### SUMMARY

The present invention wants to solve the technical problems such as the existing artificial leather degradable rate is low, the waste artificial leather causes environmental pollution, is easy to turn yellow and has peculiar smell, is to provide a preparation method of aromatic citrus peel artificial leather, the citrus peel waste is utilized, and the artificial leather prepared has strong oxidant resistance and is not easy to turn yellow, has the effect of sterilization, deodorization;

The present invention is realized like this: a method for preparing aromatic citrus peel artificial leather comprises the following steps:

Step 1: The non-woven fabric is impregnated by wet impregnation process to obtain impregnated non-woven fabric;

Step 2: the impregnated non-woven fabric passes through the coating scraper, the first fabric that is configured is coated on the impregnated non-woven fabric to obtain a semi-finished artificial leather product; the formula of the first fabric is as follows: 100 parts of the first polyester polyether blended resin, 1-20 parts of citrus peel powder, 40-50 parts of dimethylformamide, 1 part of nonionic active agent, 1 part of hydrolysis resistant auxiliary, 1 part of foaming agent, 0.5 parts of leveling agent, 3 parts of color paste;

Step 3: the artificial leather semi-finished product is sent to the three-fold solidification groove for solidification treatment, and the artificial leather semi-finished product sent out from the solidification groove is washed by water washing tank to obtain bass;

Step 4: configure the second fabric and the adhesive layer base material, utilize the dry process to adhere the second fabric with texture on the surface of the aromatic citrus peel artificial leather semi-finished product, that is, the aromatic citrus peel artificial leather finished product; the formula of the second fabric is as follows: 100 parts of the second polyester polyether blended resin, 1-10 parts of citrus peel powder, 0.03 parts of waterproof auxiliary, 20-40 parts of MEK, 20-80 parts of DMF.

Further, in the first step, the formula of the impregnating material used in the wet impregnation process is as follows: 100 parts of hydrolysis-resistant impregnating resin, 210 parts of dimethylformamide, 10 parts of anti-tearing agent, 1 part of foaming agent, 1 part of anionic surfactant, 1 part of hydrolysis resistance auxiliary, 2 parts of leveling agent, 0.5 parts of softener, 10 parts of color paste; The stirring speed of min is stirred for 15-20 min until it is completely dissolved, and the viscosity is controlled at 200-260 cps.

Further, in the second step, the prepared first fabric is stirred at a high speed of 1000-1500 r/min for 30-35 min at room temperature until it is completely dissolved, stirred until the slurry is uniform, the stirring speed is reduced to 300±50 r/min and vacuum deaeration is carried out for 90 min, and the viscosity is controlled at 14000 cps-16000 cps.

Further, in the third step, the washing is washed by 15 groups, the washing sugar content of the first six groups is controlled at 20-10%, the washing sugar content of the middle six groups is controlled at 10-0%, and the washing sugar content of the latter three groups is 0%, and the washing temperature of the latter three groups is controlled at 75° C.±5; the pre-scalding is after eight rounds and the temperature is 110±Pre-scalding at 10° C., the oven is set up in five groups, of which the oven temperature of the first group is 150° C., the oven temperature of the second to fourth groups is 160° C., and the oven temperature of the fifth group is 140° C., until it is completely dry.

Further, in the fourth step, the formula of the adhesive layer base material is as follows: 100 parts of the third polyester polyether blended resin, 1-10 parts of citrus powder, 10-30 parts of MEK, and 20-50 parts of DMF, and the prepared base material of the adhesive layer is stirred at a stirring speed of 1000-1500 r/min for 15-20 minutes at room temperature until it is completely dissolved, and the viscosity is controlled at 10000-12000 cps.

Further, in the fourth step, the dry process comprises: the second fabric is dosed 180 mm, the coating rod is evenly coated on the release paper with the texture, and the 110° C. oven is placed for 2-5 min to dry; then the adhesive layer bottom material is 200 mm, the coating rod is evenly coated on the second fabric, the second fabric is evenly coated with the coating rod, and the second fabric is put into the 110° C. oven to dry for 10-30 s to semi-dry, and finally it is taken out and laminated on the artificial leather semi-finished product containing citrus powder, and finally dried in the 120° C. oven for 10-15 min.

Further, in the fourth step, the configured second fabric is stirred at a stirring speed of 1000-1500 r/min for 15-20 min at room temperature until it is completely dissolved, and the viscosity is controlled at 1800-2500 cps.

Further, the preparation process of citrus peel powder is as follows: after the citrus peel is dried, a liquid nitrogen refrigeration grinder is used to collide and grind at a high speed of-196° C. and 40-60 Hz frequency of grinding steel balls for 40-60 s, the citrus peel is crushed 3-5 times, and the crushed citrus powder reaches 80-400 mesh.

On the other hand, the aromatic citrus peel artificial leather is used in the preparation of shoes.

The advantages of the present invention are that:
1. The present invention adopts non-woven fabric as the base fabric, with wet PU process, through the innovation of process and addition ratio, the citrus peel powder of liquid nitrogen crushing is added to the fabric, and on the basis of overcoming the adverse effects of artificial leather production on environmental pollution and not easy to degrade, it gives full play to the advantages of plant artificial leather, and produces artificial leather with high environmental protection, easy to recycle, high value-added (soft and skin-friendly, good air permeability, antibacterial, good hand feel, tear resistance).
2, the preparation method of aromatic citrus peel artificial leather of the present

invention has been excellently combined with citrus peel powder and non-woven fabric through wet PU process and dry PU process, citrus peel powder is added to the first fabric, the second fabric, and the adhesive layer to make the aromatic flavor stay longer, and the aromatic citrus peel artificial leather prepared ensures the overall physical properties of artificial leather.
3. The aromatic citrus peel artificial leather of the present invention is rich in polymethoxyflavonoids, limonin compounds, volatile oils, and a large amount of cellulose; polymethoxyflavonoids and limonoid compounds have strong antioxidant effects, so that artificial leather is not easy to turn yellow after long-term use; limonin compounds have a significant inhibitory effect on fungi and pathogenic bacteria; citrus contains natural volatile oils, which can adsorb and neutralize odors, and at the same time exude a fresh aroma; the main component of a large number of cellulose is glucose, which is a polysaccharide polymer material, insoluble in water and general organic solvents, and has good chemical reaction performance and degradation performance.
4, the present invention selects the first fabric containing citrus peel powder, and the special fabric is used as the supporting structure of artificial leather, and has a certain effect on the overall support, wherein after a large number of mixed tests of different addition ratios, the final setting of citrus powder content is 1-20 parts, so as to finally ensure the stability of the whole artificial leather product.

Based on the embodiments in the present invention, all other embodiments obtained by a person skilled in the art without making creative labor belong to the scope of protection of the present invention.

### EMBODIMENT

The preparation method of aromatic citrus peel artificial leather comprises the following steps:

Step 1: The non-woven fabric is impregnated by the wet impregnation process to obtain the impregnated non-woven fabric.

Step 2: the impregnated non-woven fabric is passed through the coating scraper, the configured first fabric is coated on the impregnated non-woven fabric, the coating gap is controlled between 205±5 filaments, and the coating dosage is controlled at 1.3±0.1 kg/y, control the thickness of coating by adjusting the gap of scraper coating, obtain artificial leather semi-finished product; the formula of described first fabric is as follows: 100 parts of first polyester polyether blended resin, 1-20 parts of citrus peel powder, 40-50 parts of dimethylformamide, 1 part of nonionic active agent, 1 part of hydrolysis resistant additive, 1 part of foaming agent, 0.5 parts of leveling agent, 3 parts of color paste; the first fabric is coated on impregnated non-woven fabric to form a coated fabric.

Step 3: the artificial leather semi-finished product is sent to the three-fold solidification groove for solidification treatment, and the artificial leather semi-finished product sent out from the solidification groove is washed by the washing tank to obtain the bass; the bass is pre-scalding, dried, cooled, and the aromatic citrus peel artificial leather semi-finished product is obtained. The solidification time of the solidification tank is increased through the three-fold solidification tank, so that the slurry is more fully solidified and the bubble pores will be finer.

Step 4: configure the second fabric and the base material of the adhesive layer, and use the dry process to adhere the second fabric with texture on the surface of the semi-finished product of aromatic citrus peel artificial leather; the formula of the second fabric is as follows: 100 parts of the second polyester polyether blended resin, 1-10 parts of citrus peel powder, 0.03 parts of waterproof additives, 20-40 parts of MEK, 20-80 parts of DMF. The citrus peel powder in the second fabric has citrus peel pigment, which is a class of natural pigments with more stable performance, safe and reliable, as the main component of artificial leather additives, which can replace synthetic pigments for artificial leather coloring.

The present invention adopts non-woven fabric as the base fabric, with wet PU process, through the innovation of process and addition ratio, the citrus peel powder of liquid nitrogen crushing is added to the fabric, and on the basis of overcoming the adverse effects of artificial leather production on environmental pollution and not easy to degrade, it gives full play to the advantages of plant artificial leather, and produces artificial leather with high environmental protection, easy to recycle, high value-added (soft and skin-friendly, good air permeability, antibacterial, good hand feel, tear resistance).

The above-mentioned preparation method successively combines citrus peel powder with non-woven fabric through wet PU process and dry PU process, and adds citrus peel powder to the first fabric, the second fabric and the adhesive layer to make the aromatic flavor stay longer, and the aromatic citrus peel artificial leather prepared ensures the overall physical properties of artificial leather.

The aromatic citrus peel artificial leather prepared by the above-mentioned preparation method is rich in polymethoxyflavonoids, limonin compounds, volatile oils, and a large amount of cellulose; polymethoxyflavonoids and limonoid compounds have strong antioxidant effects, so that artificial leather is not easy to turn yellow after long-term use; limonin compounds have a significant inhibitory effect on fungi and pathogenic bacteria; citrus contains natural volatile oils, which can adsorb and neutralize odors, and at the same time exude a fresh aroma; the main component of a large number of cellulose is glucose, which is a polysaccharide polymer material, insoluble in water and general organic solvents, and has good chemical reaction performance and degradation performance.

The present invention selects the first fabric containing citrus peel powder, and this special fabric is used as the supporting structure of artificial leather, and has a certain effect on the overall support, wherein after a large number of mixing tests of different addition ratios, the final setting of citrus powder content is 1-20 parts, so as to finally ensure the stability of the whole artificial leather product.

In the present invention, the preparation process of citrus peel powder is as follows: after the citrus peel is dried, the liquid nitrogen refrigeration grinding machine (JXFSTPRP-II) produced by Shanghai Jingxin Company is used to collide and grind at a high speed of-196° C. and the 40-60 Hz frequency of grinding steel balls for 40-60 s, and the citrus peel is crushed 3-5 times, and the crushed citrus powder reaches 80-400 mesh. The temperature of liquid nitrogen is −196° C., which can not only make various tissue components not easy to be destroyed or degraded, but also make the tissue hard, and the brittleness increases and is easy to grind.

In the first step, the composition of the non-woven fabric contains nylon and polyester, and nylon is used to balance the hand comfort. The thickness of the non-woven fabric is controlled at 0.7-0.8 mm, the gram weight is 190-210 g, the blasting is 15kgf/cm2, the tensile strength is >260 N/3 CM, the weft >is 260 N/3 CM, the elongation at break is 40-70 in the warp direction, the weft direction is 50-90, and the tear strength is >50.

In the first step, the formula of the imprequent used in the wet impregnation process is as follows: 100 parts of hydrolysis-resistant impregnating resin, 210 parts of dimethylformamide, 10 parts of anti-tear agent, 1 part of foaming agent, 1 part of anionic surfactant, 1 part of hydrolysis resistance auxiliary, 2 parts of leveling agent, 0.5 parts of softener, 10 parts of color paste, and the prepared impregnate is 1000-1200 r/at room temperature. The stirring speed of min is stirred for 15-20 min until it is completely dissolved, and the viscosity is controlled at 200-260 cps.

The hydrolysis-resistant impregnating resin is a hydrolysis-resistant impregnating resin that does not contain fluorine compounds, and its solid content is 29-32%, the 100% modulus is 25-30, the tensile strength is >15 MPa, and the viscosity range is 10-120,000 CPS/25° C., and the resin is faster when the DMF aqueous solution solidifies, and the bubble cells will be larger, and the overall air permeability and hand feel are also improved. the anti-tearing agent is a mixture of natural rubber and polyurethane; the anionic surfactant sodium stearate; the hydrolysis resistant auxiliary is a polymeric carbide diimine to enhance the tear strength; the leveling agent is an acrylic acid leveling agent; the softener is anionic alkyl succinate, which enhances the overall softness and feels better; the foaming agent is a polydimethylsiloxane, and the foaming agent is added to the formula in order to enlarge the bubble pores of the coated fabric, so that the overall feel resilience is better.

In the second step, the prepared first fabric is stirred at a high speed of 1000-1500 r/min for 30-35 min at room temperature until it is completely dissolved, stirred until the slurry is uniform, the stirring speed is reduced to 300±50 r/min and vacuum deaeration is carried out for 90 min, and the viscosity is controlled at 14000 cps-16000 cps.

The first polyester polyether blended resin is a polyester polyether blended resin that does not contain fluorine compounds, and its solid content is 35-38%, 100% modulus is 50-55, tensile strength >45MPa, elongation ≥500, viscosity range 16-180,000 CPS/25° C. The nonionic active agent is glycerol. The hydrolysis resistant additive is a polymeric carbodiimide. The foaming agent is polydimethylsiloxane to enlarge the bubble cell of PU coating. The leveling agent is an acrylic leveling agent. The first fabric is filled with liquid nitrogen crushed citrus peel powder, and the resin is made of polyester polyether blended resin without fluorine compounds, which has high solid content, excellent leather resilience and high peeling strength.

In the third step, the washing is washed through 15 groups, the washing sugar content of the first six groups is controlled at 20-10%, the washing sugar content of the middle six groups is controlled at 10-0%, and the washing sugar content of the last three groups is 0%;

and the washing temperature of the last three groups is controlled at 75° C.±5; the pre-scalding is pre-ironing after eight rounds and the temperature is 110±10° C.; the oven is provided with five groups, wherein the oven temperature of the first group is 150° C., the oven temperature of the second to four groups is 160° C., and the oven temperature of the fifth group is 140° C., until it is completely dried.

In the fourth step, in the second fabric formulation, the second polyester polyether blended resin is a polyester polyether blended resin without fluorine compounds, and its solid content is 30-35%, and the 100% modulus is 40-50. The waterproof additive is a polymeric carbide diimide.

In the fourth step, the formula of the adhesive layer is as follows: 100 parts of the third polyester polyether blended resin, 1-10 parts of citrus peel powder, 10-30 parts of MEK, 20-50 parts of DMF, and the base material of the configured adhesive layer is stirred for 15-20 minutes at a stirring speed of 1000-1500 r/min at room temperature until it is completely dissolved, and the viscosity is controlled at 10000-12000 cps. The third polyester polyether blend resin is a polyester polyether blend resin that does not contain fluorine compounds, and its solid content is 40-45%, and the 100% modulus is 30-45.

In the fourth step of the step, the dry process comprises: the second fabric is dosed

180 mm, the release paper with texture is uniformly coated with a coating rod, and it is dried in a 110° C. oven for 2-5 min; then the bottom material of the adhesive layer is paid 200 mm, and the second fabric is evenly coated with a coating rod, and it is put into a 110° C. oven to dry for 10-30 s until it is semi-dry, and finally it is taken out and laminated on the artificial leather semi-finished product containing citrus powder, and finally dried in a 120° C. oven for 10-15 min.

In step 4, the configured second fabric is stirred at a stirring speed of 1000-1500 r/min for 15-20 min at room temperature until it is completely dissolved, and the viscosity is controlled at 1800-2500 cps.

The beneficial effects of aromatic citrus peel artificial leather prepared by the preparation method of this embodiment are illustrated below by several experimental groups.

### Experimental Group 1

The preparation method of aromatic citrus peel artificial leather comprises the following steps:

Step 1: The non-woven fabric is impregnated by the wet impregnation process to obtain the impregnated non-woven fabric. The storage frame is unwinded, and its speed is controlled at 10-15m/min. The formula of described impregnating material is as follows: 100 parts of hydrolysis-resistant type impregnating resin, 210 parts of dimethylformamide, 10 parts of anti-tearing agent, 1 part of foaming agent, 1 part of anionic surfactant, 1 part of hydrolysis resistant auxiliary, 2 parts of leveling agent, 0.5 parts of softener, 10 parts of color paste; the prepared impregnate is stirred for 15-20 min at the stirring speed of 1000-1200 r/min at room temperature until it is completely dissolved, and the viscosity is controlled at 200-260 cps.

Step 2: the impregnated non-woven fabric passes through the coating scraper, the first

fabric that is configured is coated on the impregnated non-woven fabric, the coating gap is controlled between 205±5 filaments, and the coating payment is controlled at 1.3±0.1 kg/y, and the semi-finished artificial leather is obtained, and the coating surface condition is observed, and the abnormality is dealt with in time. The formula of the first fabric is as follows: 100 parts of the first polyester polyether blended resin, 15 parts of citrus peel powder, 45 parts of dimethylformamide, 1 part of nonionic active agent, 1 part of hydrolysis resistant auxiliary, 1 part of foaming agent, 0.5 parts of leveling agent, 3 parts of color paste; Described citrus peel powder uses liquid nitrogen freezing grinder at −196° C. low temperature and grinding steel ball 40-60 Hz frequency at high speed collision grinding for 40-60s, crushes citrus peel 3-5 times, crushes citrus powder reaches 400 mesh.

Step 3: the artificial leather semi-finished product is sent to the three-fold solidification groove for solidification treatment, and the artificial leather semi-finished product sent out from the solidification groove is washed by the washing tank to obtain the bass; the semi-finished product of the artificial leather is obtained by pre-scalding, drying, cooling, and the aromatic citrus peel artificial leather semi-finished product is obtained. During the coagulation operation, the coagulation sugar content is controlled at 18-21% (the sugar content is the DMF concentration in the DMF aqueous solution, which is obtained by the Abbe refractometer, and the following sugar content is obtained from this), and the temperature is controlled at 30±2° C. The length of the three-fold solidification tank is preferably set to 30 meters. The bass after the water washing tank is pre-scalded by eight rounds (temperature of 110±10° C.) ironing rollers, and the pre-scalded bass is dried in the oven, and the temperature of the oven is 150° C. in the first group, 160° C. in the second to fourth groups, and 140° C. in the fifth group until it is completely dry, and the thickness of the winding is 1.15-1.25 mm and the width is 145-147 cm.

Step 4: Configure the second fabric and the adhesive layer base material, and use the dry process to adhere the second fabric with texture on the surface of the semi-finished aromatic citrus peel artificial leather, that is, the finished aromatic citrus peel artificial leather is obtained. The formula of the second fabric is as follows: 100 parts of the second polyester polyether blended resin, 5 parts of citrus peel powder, 0.03 parts of waterproof additives, 30 parts of MEK, 50 parts of DMF; the prepared second fabric is stirred at a stirring speed of 1000-1500 r/min for 15-20 min at room temperature until it is completely dissolved, and the viscosity is controlled at 1800-2500 cps. The formula of described adhesive layer bottom material is as follows: 100 parts of the third polyester polyether blended resin, 5 parts of citrus peel powder, 20 parts of MEK, 35 parts of DMF; the prepared adhesive layer bottom material is stirred for 15-20 minutes at the stirring speed of 1000-1500 r/min at room temperature until it is completely dissolved, and the viscosity is controlled at 10000-12000 cps. The configured second fabric is evenly coated on the release paper with a texture by using a coating rod, and is dried in a 110° C. oven for 2-5 minutes; then the bottom material of the adhesive layer is 200 mm and evenly coated on the fabric with a coating rod, and it is baked in a 110° C. oven for 10-30s until it is semi-dry, and finally taken out and laminated on the artificial leather semi-finished products containing citrus powder, and finally dried in a 120° C. oven for 10-15 min.

Experimental group 2

The preparation method of aromatic citrus peel artificial leather comprises the following steps:

Step 1: The non-woven fabric is impregnated by the wet impregnation process to obtain the impregnated non-woven fabric. The storage frame is unwinded, and its speed is controlled at 10-15m/min. The formula of described impregnating material is as follows: 100 parts of hydrolysis-resistant type impregnating resin, 210 parts of dimethylformamide, 10 parts of anti-tearing agent, 1 part of foaming agent, 1 part of anionic surfactant, 1 part of hydrolysis resistant auxiliary, 2 parts of leveling agent, 0.5 parts of softener, 10 parts of color paste; the prepared impregnate is stirred for 15-20 min at the stirring speed of 1000-1200r/min at room temperature until it is completely dissolved, and the viscosity is controlled at 200-260cps.

Step 2: the impregnated non-woven fabric passes through the coating scraper, the first fabric that is configured is coated on the impregnated non-woven fabric, the coating gap is controlled between 205±5 filaments, and the coating payment is controlled at 1.3±0.1 kg/y, and the semi-finished artificial leather is obtained, and the coating surface condition is observed, and the abnormality is dealt with in time. The formula of the first fabric is as follows: 100 parts of the first polyester polyether blended resin, 1 part of citrus peel powder, 40 parts of dimethylformamide, 1 part of nonionic active agent, 1 part of hydrolysis resistant auxiliary, 1 part of foaming agent, 0.5 parts of leveling agent, 3 parts of color paste; Described citrus peel powder uses liquid nitrogen freezing grinder at −196° C. low temperature and grinding steel ball 40-60 Hz frequency at high speed collision grinding for 40-60 s, crushes citrus peel 3-5 times, crushes citrus powder reaches 400 mesh.

Step 3: the artificial leather semi-finished product is sent to the three-fold solidification groove for solidification treatment, and the artificial leather semi-finished product sent out from the solidification groove is washed by the washing tank to obtain the bass; the semi-finished product of the artificial leather is obtained by pre-scalding, drying, cooling, and the aromatic citrus peel artificial leather semi-finished product is obtained. During the coagulation operation, the coagulation sugar content is controlled at 18-21% (the sugar content is the DMF concentration in the DMF aqueous solution, which is obtained by the Abbe refractometer, and the following sugar content is obtained from this), and the temperature is controlled at 30±2° C. The length of the three-fold solidification tank is preferably set to 30 meters. The bass after the water washing tank is pre-scalded by eight rounds (temperature of 110±10° C.) ironing rollers, and the pre-scalded bass is dried in the oven, and the temperature of the oven is 150° C. in the first group, 160° C. in the second to fourth groups, and 140° C. in the fifth group until it is completely dry, and the thickness of the winding is 1.15-1.25 mm and the width is 145-147 cm.

Step 4: Configure the second fabric and the adhesive layer base material, and use the

dry process to adhere the second fabric with texture on the surface of the semi-finished aromatic citrus peel artificial leather, that is, the finished aromatic citrus peel artificial leather is obtained.

The formula of the second fabric is as follows: 100 parts of the second polyester polyether blended resin, 1 part of citrus peel powder, 0.03 parts of waterproof additives, 20 parts of MEK, 20 parts of DMF; the prepared second fabric is stirred at a stirring speed of 1000-1500 r/min for 15-20 min at room temperature until it is completely dissolved, and the viscosity is controlled at 1800-2500 cps. The formula of described adhesive layer bottom material is as follows: 100 parts of the third polyester polyether blended resin, 1 part of citrus peel powder, 10 parts of MEK, 20 parts of DMF; the prepared adhesive layer bottom material is stirred for 15-20 minutes at the stirring speed of 1000-1500 r/min at room temperature until it is completely dissolved, and the viscosity is controlled at 10000-12000 cps. The configured second fabric is evenly coated on the release paper with a texture by using a coating rod, and is dried in a 110° C. oven for 2-5 minutes; then the bottom material of the adhesive layer is 200 mm and evenly coated on the fabric with a coating rod, and it is baked in a 110° C. oven for 10-30 s until it is semi-dry, and finally taken out and laminated on the artificial leather semi-finished products containing citrus powder, and finally dried in a 120° C. oven for 10-15 min.

### Experimental Group 3

The preparation method of aromatic citrus peel artificial leather comprises the following steps:

Step 1: The non-woven fabric is impregnated by the wet impregnation process to obtain the impregnated non-woven fabric. The storage frame is unwinded, and its speed is controlled at 10-15m/min. The formula of described impregnating material is as follows: 100 parts of hydrolysis-resistant type impregnating resin, 210 parts of dimethylformamide, 10 parts of anti-tearing agent, 1 part of foaming agent, 1 part of anionic surfactant, 1 part of hydrolysis resistant auxiliary, 2 parts of leveling agent, 0.5 parts of softener, 10 parts of color paste; the prepared impregnate is stirred for 15-20 min at the stirring speed of 1000-1200 r/min at room temperature until it is completely dissolved, and the viscosity is controlled at 200-260 cps.

Step 2: the impregnated non-woven fabric passes through the coating scraper, the first fabric that is configured is coated on the impregnated non-woven fabric, the coating gap is controlled between 205±5 filaments, and the coating payment is controlled at 1.3±0.1 kg/y, and the semi-finished artificial leather is obtained, and the coating surface condition is observed, and the abnormality is dealt with in time. The formula of the first fabric is as follows: 100 parts of the first polyester polyether blended resin, 20 parts of citrus peel powder, 50 parts of dimethylformamide, 1 part of nonionic active agent, 1 part of hydrolysis resistant auxiliary, 1 part of foaming agent, 0.5 parts of leveling agent, 3 parts of color paste; Described citrus peel powder uses liquid nitrogen freezing grinder at-196° C. low temperature and grinding steel ball 40-60 Hz frequency at high speed collision grinding for 40-60 s, crushes citrus peel 3-5 times, crushes citrus powder reaches 400 mesh.

Step 3: the artificial leather semi-finished product is sent to the three-fold solidification groove for solidification treatment, and the artificial leather semi-finished product sent out from the solidification groove is washed by the washing tank to obtain the bass; the semi-finished product of the artificial leather is obtained by pre-scalding, drying, cooling, and the aromatic citrus peel artificial leather semi-finished product is obtained. During the coagulation operation, the coagulation sugar content is controlled at 18-21% (the sugar content is the DMF concentration in the DMF aqueous solution, which is obtained by the Abbe refractometer, and the following sugar content is obtained from this), and the temperature is controlled at 30±2° C. The length of the three-fold solidification tank is preferably set to 30 meters. The bass after the water washing tank is pre-scalded by eight rounds (temperature of 110±10° C.) ironing rollers, and the pre-scalded bass is dried in the oven, and the temperature of the oven is 150° C. in the first group, 160° C. in the second to fourth groups, and 140° C. in the fifth group until it is completely dry, and the thickness of the winding is 1.15-1.25 mm and the width is 145-147 cm.

Step 4: Configure the second fabric and the adhesive layer base material, and use the dry process to adhere the second fabric with texture on the surface of the semi-finished aromatic citrus peel artificial leather, that is, the finished aromatic citrus peel artificial leather is obtained. The formula of the second fabric is as follows: 100 parts of the second polyester polyether blended resin, 10 parts of citrus peel powder, 0.03 parts of waterproof additives, 40 parts of MEK, 80 parts of DMF, and the prepared second fabric is stirred at the stirring speed of 1000-1500r/min for 15-20 min at room temperature until it is completely dissolved, and the viscosity is controlled at 1800-2500 cps. The formula of described adhesive layer bottom material is as follows: 100 parts of the third polyester polyether blended resin, 10 parts of citrus peel powder, 30 parts of MEK, 50 parts of DMF, and the prepared adhesive layer bottom material is stirred for 15-20 minutes at the stirring speed of 1000-1500 r/min at room temperature until it is completely dissolved, and the viscosity is controlled at 10000-12000 cps. The configured second fabric is evenly coated on the release paper with a texture by using a coating rod, and is dried in a 110° C. oven for 2-5 minutes; then the bottom material of the adhesive layer is 200 mm and evenly coated on the fabric with a coating rod, and it is baked in a 110° C. oven for 10-30s until it is semi-dry, and finally taken out and laminated on the artificial leather semi-finished products containing citrus powder, and finally dried in a 120° C. oven for 10-15 min.

TABLE 1
Experimental groups 1 to 3 prepared artificial leather related parameters test

| | Test values | | | |
|---|---|---|---|---|
| | Experimental | Experimental | Experimental | |
| Test items | group 1 | group 1 | group 3 | Test Method: |
| Thickness | 1.15-1.25 | 1.15-1.25 | 1.16-1.25 | AN-PZ-W-055 |
| (mm) | | | | |
| Effective | 140-142 | 140-142 | 140-142 | [symbol] |
| Width(cm) | | | | |
| Rupture | ≥23 | ≥25 | ≥20 | AN-PZ-W-060 |
| Strength | | | | |
| (kgf/cm2) | | | | |
| Tensile | Meridional ≥32 | Meridional ≥35 | Meridional ≥30 | AN-PZ-W-057 |
| load(kg/2.54 | Weft ≥32 | Weft ≥35 | Weft ≥30 | |
| cm) | | | | |
| Elongation (%) | Meridional: 40-80 | Meridional: 40-80 | Meridional: 40-80 | AN-PZ-W-057 |
| | Weft: 60-120 | Weft: 60-120 | Weft: 60-120 | |
| Conventional | Warp and weft ≥105 | Warp and weft ≥110 | Warp and weft ≥100 | AN-PZ-W-052 |
| peel load | | | | |
| (N/3 cm) | | | | |
| Tear of pants | Warp and weft ≥60 | Warp and weft ≥65 | Warp and weft ≥60 | AN-PZ-W-064 |
| (N/3 cm) | | | | |
| Hydrolysis | Warp and weft ≥75 | Warp and weft ≥80 | Warp and weft ≥70 | AN-PZ-W-052 |
| resistant for | | | | |
| 24 H Peeling | | | | |
| load (N/3 cm) | | | | |
| Softness value | 2.3-2.6 | 2.3-2.6 | 2.3-2.5 | AN-PZ-W-061 |
| PH value | 5.5-7.5 | 5.5-7.5 | 4.5-7.5 | AN-PZ-W-105 |
| 2 h 80° C. water | No cracks | No cracks | No cracks | AN-PZ-W-052 |
| bath | | | | |

Conclusion: According to Table 1, it can be seen that the aromatic citrus peel artificial leather prepared by several experimental groups has a conventional peeling load of more than 100N/3 cm, and the softness test value is between 2.3-2.6, indicating that the aromatic citrus peel artificial leather products not only meet the physical properties, but also feel soft, have good skin-friendliness, and are resistant to hydrolytic peeling load for 24H Warp and weft≥70, It shows that it is easy to hydrolyze, environmentally friendly, recyclable, and has the advantages of health, safety, sustainability and environmental friendliness.

Although the specific embodiments of the present invention have been described above, those skilled in the art should understand that the specific embodiments we have described are only illustrative and not used to limit the scope of the invention, and that the equivalent modifications and changes made by those skilled in the art in accordance with the spirit of the invention should be covered by the protection of the claims of the present invention.

What is claimed is:

1. The preparation method of aromatic citrus peel artificial leather, which is characterized in that: comprises the following steps:
Step 1: The non-woven fabric is impregnated by wet impregnation process to obtain impregnated non-woven fabric;
Step 2: the impregnated non-woven fabric passes through the coating scraper, the first fabric that is configured is coated on the impregnated non-woven fabric to obtain a semi-finished artificial leather product; the formula of the first fabric is as follows: 100 parts of the first polyester polyether blended resin, 1-20 parts of citrus peel powder, 40-50 parts of dimethylformamide, 1 part of nonionic active agent, 1 part of hydrolysis resistant auxiliary, 1 part of foaming agent, 0.5 parts of leveling agent, 3 parts of color paste;
Step 3: the artificial leather semi-finished product is sent to the three-fold solidification groove for solidification treatment, and the artificial leather semi-finished product sent out from the solidification groove is washed by water washing tank to obtain bass;
Step 4: configure the second fabric and the adhesive layer base material, utilize the dry process to adhere the second fabric with texture on the surface of the aromatic citrus peel artificial leather semi-finished product, that is, the aromatic citrus peel artificial leather finished product; the formula of the second fabric is as follows: 100 parts of the second polyester polyether blended resin, 1-10 parts of citrus peel powder, 0.03 parts of waterproof auxiliary, 20-40 parts of MEK, 20-80 parts of DMF.

2. The preparation method of aromatic citrus peel artificial leather as claimed in claim 1, wherein: in step 1, the formula of the impregnating material used in the wet impregnation process is as follows: 100 parts of hydrolysis-resistant impregnating resin, 210 parts of dimethylformamide, 10 parts of anti-tearing agent, 1 part of foaming agent, 1 part of anionic surfactant, 1 part of hydrolysis resistant auxiliary, 2 parts of leveling agent, 0.5 parts of softener, 10 parts of color paste; The stirring speed of min is stirred for 15-20 min until it is completely dissolved, and the viscosity is controlled at 200-260 cps.

3. The preparation method of aromatic citrus peel artificial leather as claimed in claim 1, wherein: in step two, the first fabric is prepared at room temperature at a stirring speed of 1000-1500 r/min for high-speed stirring for 30-35 min until completely dissolved; stirring until the slurry is uniform, the stirring speed is reduced to 300±50 r/min and vacuum deaeration is carried out for 90 min, and the viscosity is controlled at 14000cps-16000cps.

4. The preparation method of aromatic citrus peel artificial leather as claimed in claim 1, it is characterized in that: in step 3, described water washing is washed through 15 groups, and the washing sugar content of the first six groups is controlled at 20-10%, the washing sugar content of the middle six groups is controlled at 10-0%, and the washing sugar content of the last three groups is 0%, and the washing temperature of the last three groups is controlled at 75° C.±5; the pre-scalding is after eight rounds and the temperature is 110±Pre-scalding at 10° C., the oven is set up in five groups, of which the oven temperature of the first group is 150° C., the oven temperature of the second to fourth groups is 160° C., and the oven temperature of the fifth group is 140° C., until it is completely dry.

5. The preparation method of aromatic citrus peel artificial leather as claimed in claim 1, it is characterized in that: in step four, the formula of described adhesive layer bottom material is according to the number of component mass parts: 100 parts of the third polyester polyether blended resin, 1-10 parts of citrus powder, 10-30 parts of MEK, 20-50 parts of DMF; min stirring speed for 15-20 minutes until completely dissolved, viscosity controlled at 10000-12000 cps.

6. The preparation method of aromatic citrus peel artificial leather as claimed in claim 5, wherein: in step four, described dry process comprises: the second fabric is dosed 180 mm, the coating rod is evenly coated on the release paper with texture, and the 110° C. oven is placed for 2-5 min drying; the adhesive layer bottom material is paid 200 mm again, the second fabric is evenly coated with the coating rod, and the 110° C. oven is put in to dry for 10-30 s to semi-dry, and finally taken out and laminated on the artificial leather semi-finished product containing citrus powder, and finally dried in the 120° C. oven for 10-15 min.

7. The preparation method of aromatic citrus peel artificial leather as claimed in claim 6, wherein: in step four, the configured second fabric is stirred at a stirring speed of 1000-1500 r/min for 15-20 min at room temperature until it is completely dissolved, and the viscosity is controlled at 1800-2500 cps.

8. The preparation method of aromatic citrus peel artificial leather as claimed in claim 1, wherein: the preparation process of citrus peel powder is as follows: after the citrus peel is dried, use a liquid nitrogen freezer grinding machine to collide and grind 40-60s at a high speed at a low temperature of −196° C. and a 40-60 Hz frequency of grinding steel balls, crush the citrus peel 3-5 times, and crush the citrus powder to reach 80-400 mesh.

9. An application based on any one of claims 1-8 of aromatic citrus peel artificial leather, wherein: described aromatic citrus peel artificial leather is used for preparing shoes.
